(19) United States
(12) Patent Application Publication
(10) Pub. No.: US 2008/0283255 A1
(43) Pub. Date: Nov. 20, 2008

(54) Liquid Nitrogen Enabler Apparatus

(76) Inventor: Denyse DuBrucq, Cedarville, OH (US)

Correspondence Address: BOYLE FREDRICKSON S.C., 840 North Plankinton Avenue, MILWAUKEE, WI, 53203, US

(21) Appl. No.: 11/750,149

(22) Filed: May 17, 2007

(51) Int. Cl. A62C 35/00

(52) U.S. Cl. 169/5; 169/30

(57) ABSTRACT

A Liquid Nitrogen Enabler Apparatus is disclosed herein, wherein the apparatus may be configured to protect the earth, people and property. The apparatus is configured to distribute liquid nitrogen that converts to nitrogen gas to achieve its desired effects. Nitrogen gas carries the temperature, the inertness, and the tendency to cloud, gather amongst itself with the exclusion of other gases. Combining the thermal qualities with the inertness of the nitrogen gas, fires and other such crises are handled. There are various advantages associated with treating fires and other such crises with liquid nitrogen such as that when the liquid nitrogen converts into a gaseous form and is applied to a fire draft, rather than directly to the fire itself. The fire draft will pull the gaseous nitrogen into the fire, thus ending the burn.

### BACKGROUND OF THE INVENTION

1. Field of the Invention

Nitrogen chemistry has a wide range of inorganic, organic and bio chemical configurations, some of which are explosive as TNT. The ground state of Nitrogen chemistry is molecular Nitrogen, N₂, which is as inert as Argon, a noble gas, and is so stable that it can only be “fixed”, i.e., combined in a reaction with other elements, in nature through lightning or by specific microbes such as rhizome bacteria in plant root systems such as beans and peanuts. Nitrogen, liquid or gaseous, does not conduct electricity, making it ideal for use against electrical fires and for preserving IT equipment in a fire. Therefore, using molecular Nitrogen to handle a wide variety of crises is relatively safe and efficient.

Thermally, Liquid Nitrogen temperature ranges between −210° C. and −195.8° C. At temperatures above −195.8° C. it evaporates into gaseous Nitrogen, which then changes to ambient temperatures. No natural temperature on earth is in the same liquid/gas conversion range as Nitrogen, which makes Nitrogen a reliable element to use even in the coldest climates. Gaseous Nitrogen best fights fires and penetrates such events without direct application. In winter, freezing water sources have often presented various problems. For instance, water supplies may be frozen. In addition, applying water to fires and other such events may result in creating a frozen structure and may freeze the ground surfaces nearby, thus making subsequent walking and driving in the general area perilous. Furthermore, freezing water that is applied to structures may result in damage to the structural integrity of the structures.

Economically, the liquification of gases is an established industry worldwide. Air Products and Chemicals, Linde/BOC, and Praxair are examples of companies in the field with distributors throughout most states in the United States and around the world. Retail costs for small quantities from distributors often costs approximately $4 per liter, while routinely distributed Liquid Nitrogen costs around $1 per gallon and bulk purchases can cost as little as $0.35 per gallon.

Some fires are so severe, that if they are fought with water, the community water supplies can be exhausted. If seawater or the like is used, its salts may pollute the surrounding land. However, if Liquid Nitrogen is used, less liquid is required because the liquid nitrogen becomes gaseous Nitrogen which expands to 250 times the volume of liquid. A 7,500-gallon load of Liquid Nitrogen provides 1,875,000 gallons of Nitrogen gas, at $0.0014 per gallon. In addition, when using liquid nitrogen, there is neither flooding nor icing since the residual material is Nitrogen gas.

Physiologically, Nitrogen molecules cluster (band together) expelling other material both as liquid and gas. As a liquid, the liquid has a high surface tension, bubbling like water on a water-sealed surface. As such, other materials are either kept to the outer surface or grouped in the liquid as large spherical inclusions. Inclusions can include, for example, dry ice (solid Carbon dioxide) or ice (solid water) from the surrounding air. Though the gaseous Nitrogen is clear, it too isolates contaminants making pure Nitrogen gas a safety concern. When using Nitrogen in large quantities or storing large quantities of Nitrogen, a breathing apparatus should be available to guarantee Oxygen availability.

Clustering and evaporation combine to protect warm surfaces from being radically cooled when Liquid Nitrogen passes over them. Upon contact, a gaseous layer is formed between the Liquid Nitrogen and the warm surface. If the Liquid Nitrogen is separated into drops and allowed to fall to the surface, it evaporates and targets the cold at the spot below the drop and cold gas emanates from that location.

The present invention relates to a cryo-technology apparatus for applying liquid nitrogen to handle crises situations. For use with fires, it must evaporate the liquid into gas to counter the burn and take fuel to below ignition temperatures. For use in freezing situations, it is preferably packaged to provide maximum cold exposure to the material. For use with tornadoes, it must be applied without any water condensation on the applicators. For spill and toxin control its cold transfer must be optimum. For use in stack gas scrubbers, it must be cycled to remove the condensed material with proper receptacles. And for use with non-lethal weaponry, again, like with fires, it is the pure, inert gas where needed that makes the use effective.

2. Discussion of the Related Art

Patent application Ser. Nos. 11/544/285 and 11/706,723 disclose the following related art: U.S. Pat. No. 6,666,278 to Cicanese, U.S. Pat. No. 5,327,732 to DeAlmeida, U.S. Pat. No. 6,401,830 to Romanoff, and U.S. Pat. No. 5,197,548 to Volker. However, the aforementioned related art, suffers from various disadvantages. Such disadvantages are disclosed in U.S. patent application Ser. No. 11/544,285, which is hereby incorporated by reference.

### SUMMARY OF THE INVENTION

In accordance with one aspect of the invention, an apparatus for dispersing liquid nitrogen with a sieve so as to divide the liquid nitrogen into streams of droplets provides rapid gasification of the liquid, thus preserving the low temperature in a temperature transferring form. As such, the temperature of burning matter is brought below its ignition temperature. In addition, it cools exposed chemicals such as oils to their solid or gel phase thus preventing their dispersion. In addition, it ends dispersal of toxins from aerosols.

In another aspect of the present invention, an apparatus for dispersing liquid nitrogen with a sieve component to divide the liquid nitrogen into streams of droplets provides a clouding of gaseous nitrogen thus preserving the pure, homophobic, inert characteristics of the liquid nitrogen. Additionally, it isolates fuel from oxygen, stopping the burn. It also isolates cold areas of the dispersing apparatus to prevent frosting and icing. In addition, it dilutes and isolates released toxins within the nitrogen cloud.

In another aspect of the present invention, the apparatus of the present invention disperses liquid nitrogen a long distance from a dewar, therefore delivering the nitrogen effectively with both a mobile apparatus and an apparatus assembled at the scene surrounding a fire. To handle large fires, such as wild land and forest, tall building, and petroleum, and chemical industrial fires, one places nitrogen gas into the fire draft, which pulls the nitrogen into the main burn to quell the fire. As such, the fire can be hundreds of feet from the nitrogen source. The fire draft is eliminated upon termination of the major burn of the fire, and the fire fuel is cooled. In fires such as these, it is then safe for firefighters to enter the fire zone and complete the control of the fire though embers may persist. Application of water to these spots may be used to eliminate the remaining embers.

In accordance with another aspect of the present invention, the apparatus for dispersing liquid nitrogen has a means to lift an object to be cooled so it does not freeze to the ground. For example, this embodiment of the present invention may be used for clearing an unexploded ordnance such as landmines and Innovative Explosive Devices (IEDs), vehicle bombs and suicide bomber riggings.

In accordance with another aspect of the present invention, the apparatus for dispersing liquid nitrogen can be built into a structure saving time in the event of fire or other crises such as gas leak or hostage crisis. In this embodiment, the liquid nitrogen is added to installed delivery equipment. Commercial and industrial facilities of all kinds can elect this, some even keeping the nitrogen supply on site. It is especially important for chemical and petroleum facilities, silos, and where there is routine use and storage of flammables.

In accordance with another aspect of the present invention, cryogenic hoses can be purged of other gases by incorporating traps for liquid nitrogen that hold enough nitrogen to evaporate into nitrogen gas, which pushes other gases out of the hoses.

In accordance with another aspect of the present invention, placement and portability of sieve units can target the evaporation of liquid nitrogen to make reliable, non-lethal weaponry useful in capturing threatening beings, animals or persons.

In accordance with another aspect of the present invention, dispersal units can be placed in a matrix pattern to control large, long burning fires by systematic presentation of gaseous nitrogen into the porous rocks or material, ending the burn when oxygen is displaced by inert gas down into hot regions of the burn until the depths are at below ignition temperatures.

In accordance with another aspect of the present invention, cooling of contaminated air, like stack gas, can be done by pulsing of cooling regions of a system pulling humidity from the air and dragging down adhering particles and dissolved substances, transferring the soot for disposal, water for purification and use, and carbon dioxide for photosynthetic conversion to robust plant structure and byproduct oxygen.

In accordance with another aspect of the invention, cooling by contact with cold-transmitting pipe systems can allow an ice structure formed by the cryogenic cooling to block water flow through breaks in dams and dikes, halting of lava flow, developing solid cores in levees when threatened with hurricanes, and holding soil steady to prevent mudslides when weather situations are conducive.

In accordance with another aspect of the invention, the use of tools to gather and retain the cold gas, hold water to lift organic spills, and tongs and skimmers to remove and store the unwanted material, prevents contamination, hastens control of small fires, hastens the cooling of containers to condense and solidify contents for proper containment, storage, and disposal.

In accordance with another aspect of the invention, the apparatus of the present invention is configured to disperse cryogens into the atmosphere, for example, from an aircraft, to prevent icing of the apparatus by slow leaking liquid nitrogen into the protective tubing encasing the liquid nitrogen delivery hose. By flooding the delivery end of the dispersal equipment with evaporated nitrogen, the cold elements are bathed with inert nitrogen gas keeping the air with its content of water vapor away from the super cold apparatus on the aircraft.

In yet another aspect of the present invention, the apparatus is used for unique warning of the dispersal of nitrogen such that both the visual signal and the audio signal convey “N” “2” repeatedly. Used universally, parties in range of use of liquid nitrogen can be suitably warned by these unique signals.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a drawing in several views of the pan for the fire extinguisher version of Liquid Nitrogen firefighting equipment, for one embodiment of the present invention;

FIG. 2 is a drawing in several views of the half-circle wall mount for fixed fire control or for installing in a window at the time of a fire event or other event needing nitrogen flooding for another embodiment of the present invention;

FIG. 3 is a drawing in several views of the trough and elbows for instant installable placement in the fire draft with telescoping-legged supports for the trough system of one embodiment of the trough design of the present invention;

FIG. 4 is a drawing detailing the construction of the trough elbows and their installation in the trough system of another embodiment of the trough design of the present invention;

FIG. 5 is a drawing of the lift-mounted wand, a mobile version of the trough system and possible Liquid Nitrogen feeder to an installed trough system or fixed fire control system, one view of one embodiment of the present invention;

FIGS. 6a-d are schematic illustrations of the wand giving details of the construction, a second view of one embodiment of the invention illustrated in FIG. 5;

FIGS. 7a-d are schematic views of a circular trough design with specialty hydraulic leg units for small ordnance removal in accordance with another embodiment of the present invention;

FIG. 8 is a schematic representation of fixed fire control using liquid nitrogen, another aspect of the trough design illustrated in FIGS. 3 & 4;

FIG. 9 is a schematic representation of cryo-piping with a means of guaranteeing only nitrogen is the content of the pipe system, another aspect of fixed fire control design;

FIG. 10 is a schematic representation of a light-weight sieve unit for use as a non-lethal weapon or distant small fire control, another aspect of the pan design in FIG. 1;

FIG. 11 is a schematic representation of a fixed non-lethal weapon system for aircraft and other areas of threat of terrorism, another embodiment of the pan unit of the present invention;

FIG. 12 is a schematic representation of a pulsed applicator of liquid nitrogen for burning coalmines or other deep, long burning fires in the ground, another aspect of the pan design illustrated in FIGS. 1 & 11;

FIG. 13 is a schematic representation of a stack gas scrubber removing contaminants from burning or other caustic exhaust, another embodiment of the present invention;

FIG. 14 is a schematic representation of details of the scrubber unit showing details of construction the aspect of the scrubber design illustrated in FIG. 13;

FIG. 15 is a schematic representation of another embodiment of the present invention used to block flow through breaches in dams, dikes, and the like;

FIG. 16 shows opposite threading of pipes to allow conforming the icing pipes to the dam or dike form to first, stop the flow from a breach, and second allow repair of the breach before melting the resulting ice barrier to water flow, of the embodiment illustrated in FIG. 15.

FIG. 17 is a schematic representation another embodiment of the present invention showing means to freeze an ice core in a levee or weak soil area that might result in a mudslide where freezing is done as a crises approaches;

FIG. 18 is a schematic representation of the embodiment illustrated in FIG. 17 illustrating the use of a piping installation and freeze zone of the system;

FIG. 19 is a schematic representation of the embodiment illustrated in FIGS. 18 and 19 showing Liquid Nitrogen entry into the piping system;

FIG. 20 is a schematic representation of another embodiment of the present invention for lava flow control;

FIG. 21a is a schematic representation of another embodiment of the present invention wherein baffles and a containment means are used to stop the spewing of unwanted material in the air from an aerosol or canister, according to another embodiment of the present invention illustrated in FIG. 1;

FIG. 21b is a schematic representation of use of bottomless water containment baffles, skimmer and a containment means to stop the spread of unwanted material on the ground or pavement, according to another aspect of pan device illustrated in FIG. 1;

FIGS. 22a-c are schematic representations, wherein water filled fire hoses are used as the baffles according to a second embodiment of the apparatus in FIG. 21b;

FIGS. 22aa-bb are schematic representations of alternative embodiments of the present invention illustrated in FIGS. 1, 21, wherein the nitrogen gas is used to surround a location where prevention of wind dispersal is necessary;

FIG. 23a-k are schematic representations of another embodiment for repairing a broken pipe and baffling cold gas, according to another aspect of the present invention illustrated in FIGS. 1, 22aa-bb;

FIG. 24 is a schematic representation of another embodiment of the present invention, wherein liquid nitrogen is applied to a tornado for disrupting the tornado;

FIG. 25 is a schematic representation of a warning system for use during active application of liquid nitrogen; and

FIG. 26 is a representation of the production methods for sieve areas to make holes using a press roll.

### DETAILED DESCRIPTION OF THE PREFERRED EMBODIMENTS

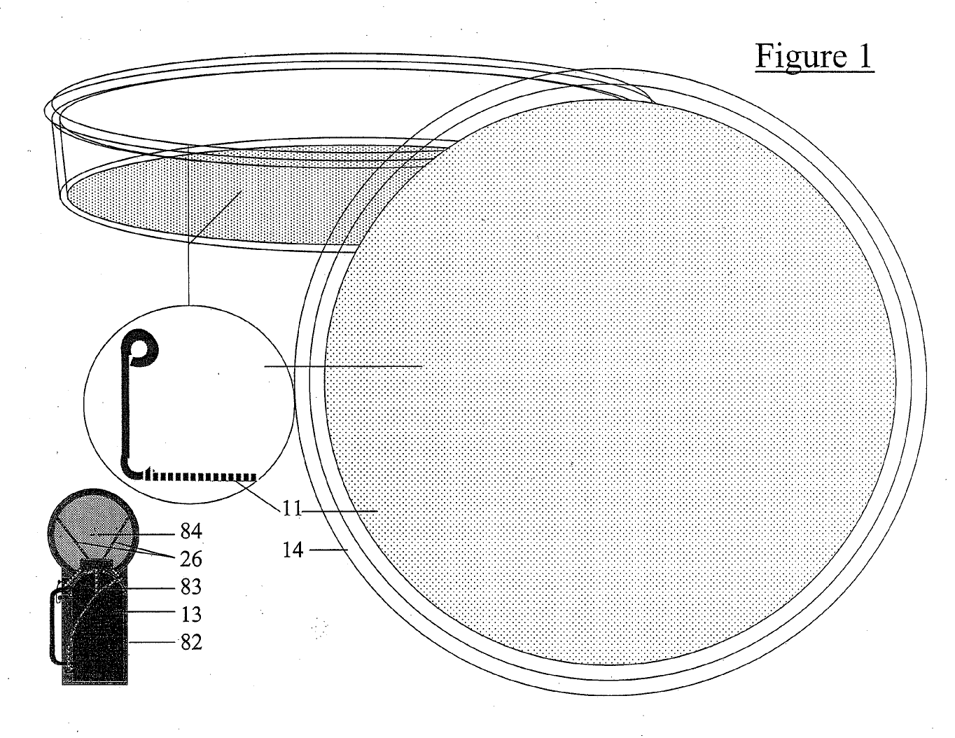

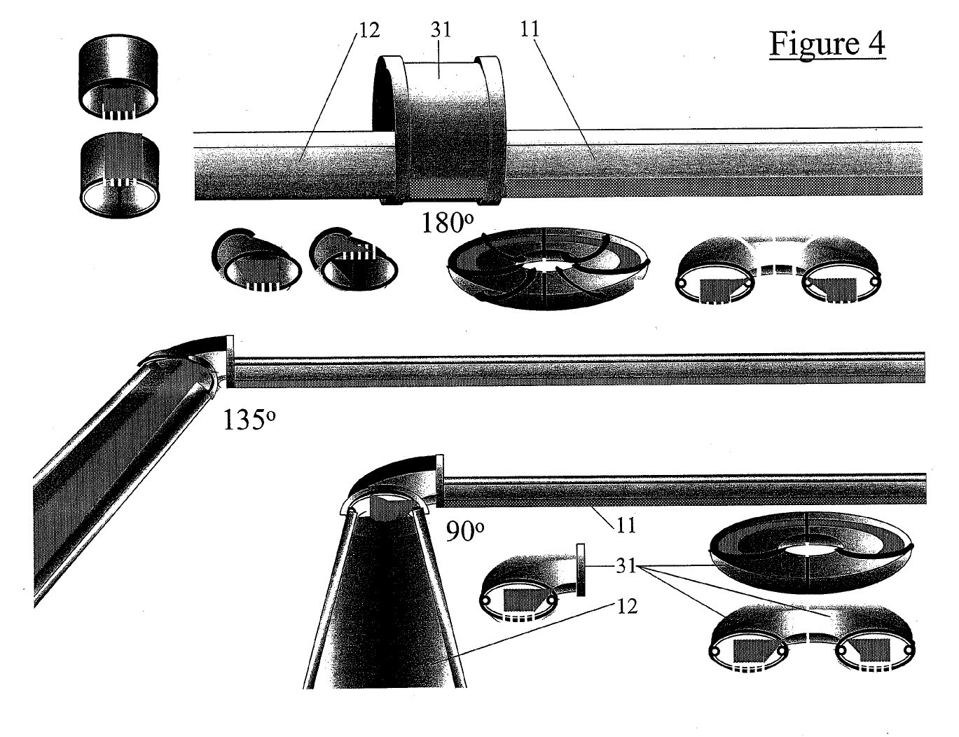

Turning now to the drawings and initially to FIGS. 1-4, an apparatus for applying liquid nitrogen to a region using, for example, a galvanized sheet material, aluminum or composite, to form a container 14 for liquid nitrogen. The container 14 having small, spaced holes 11 configured to allow the liquid nitrogen to fall in spaced drop streams for rapid evaporation is illustrated. A solid trough 12 may form an extension that precedes the point where the liquid nitrogen is delivered to. All three configurations, the pan, the wall half circle and trough system can apply the liquid nitrogen directly on the event or, alternatively, create a cloud of nitrogen gas in such a location that it is drawn into the fire in the fire draft.

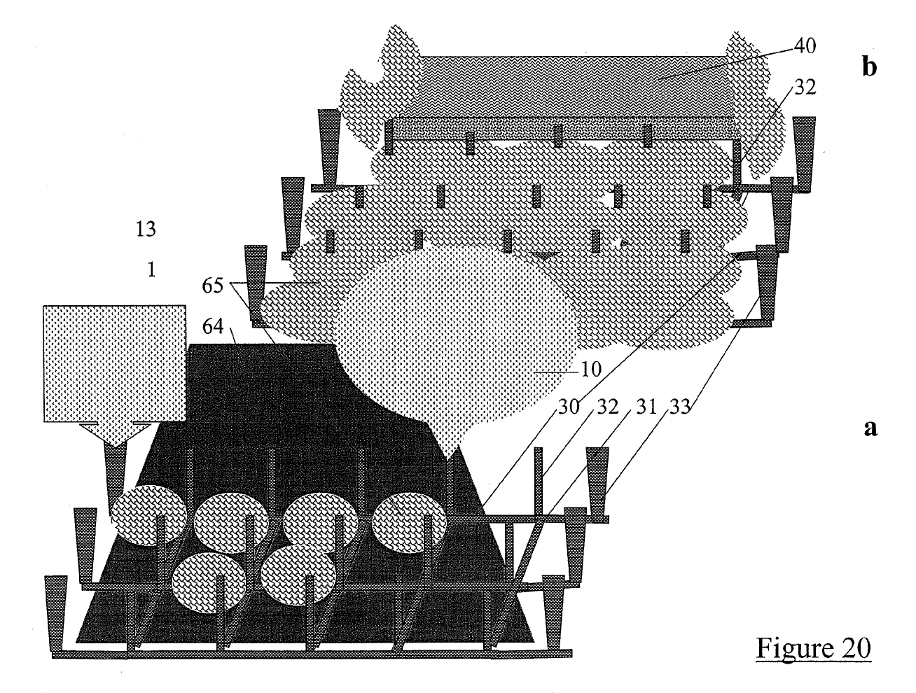

Various configurations for the invention illustrated in FIG. 1 are contemplated including supplying a dewar to hold the Liquid Nitrogen supply to facilitate portability of the unit as, for example, a fire extinguisher, wherein the fire extinguisher has a broader range of application than those presently known in the art. A holster 82 is provide, the holster having a means to secure the dewar 83 and a clip mechanism 84 to secure the pan. The pan must be durable and with sufficient strength to not flex in use, but hold a flat, sieve surface. Ties 111 connect the pan to the dewar to allow single hand use. This configuration is useful in many different applications as shown in FIGS. 20-22, which will be discussed further below.

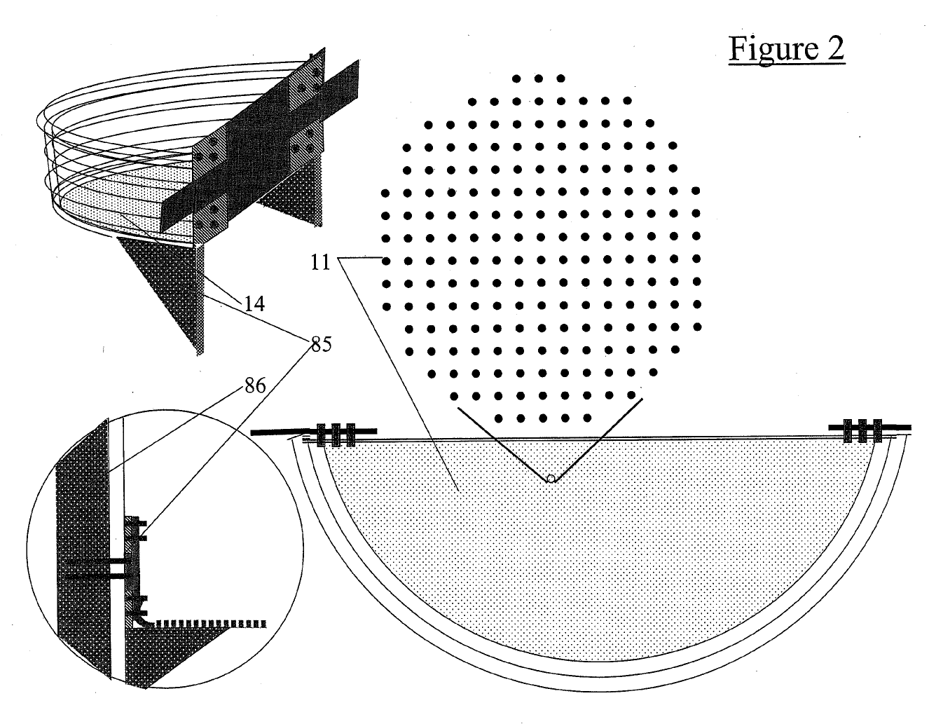

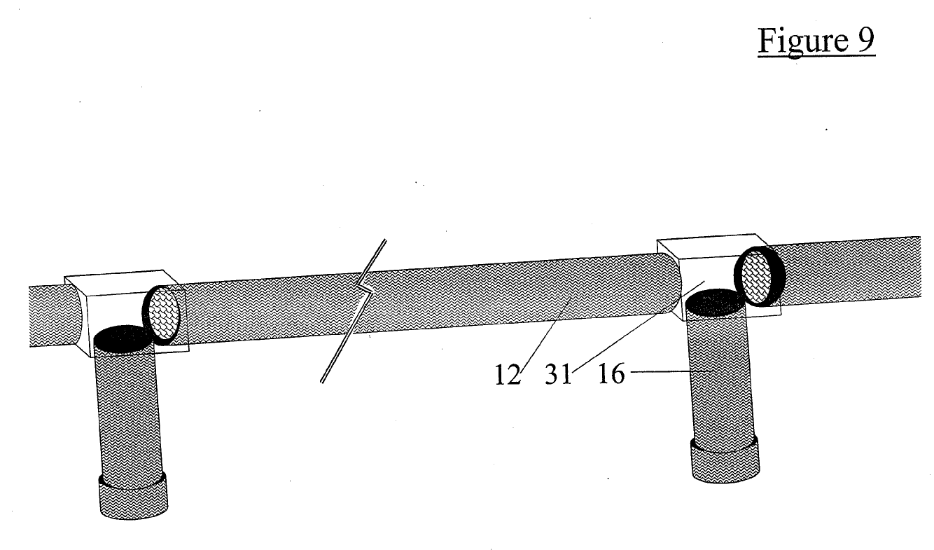

FIG. 2 illustrates a wall-mountable embodiment of the present invention that can be configured as a release segment of a fixed nitrogen system built into a structure. It has a wall mount 85 that secures it to the wall 86. In plumbing the liquid nitrogen delivery system, a funnel or the like may be used to feed this unit to allow the space to be flooded with nitrogen gas. FIG. 9 shows cyro-piping carrying the liquid nitrogen to this wall unit. A variation used by first responders allows the unit to be inset in a window during an event in a facility without fixed nitrogen crises control.

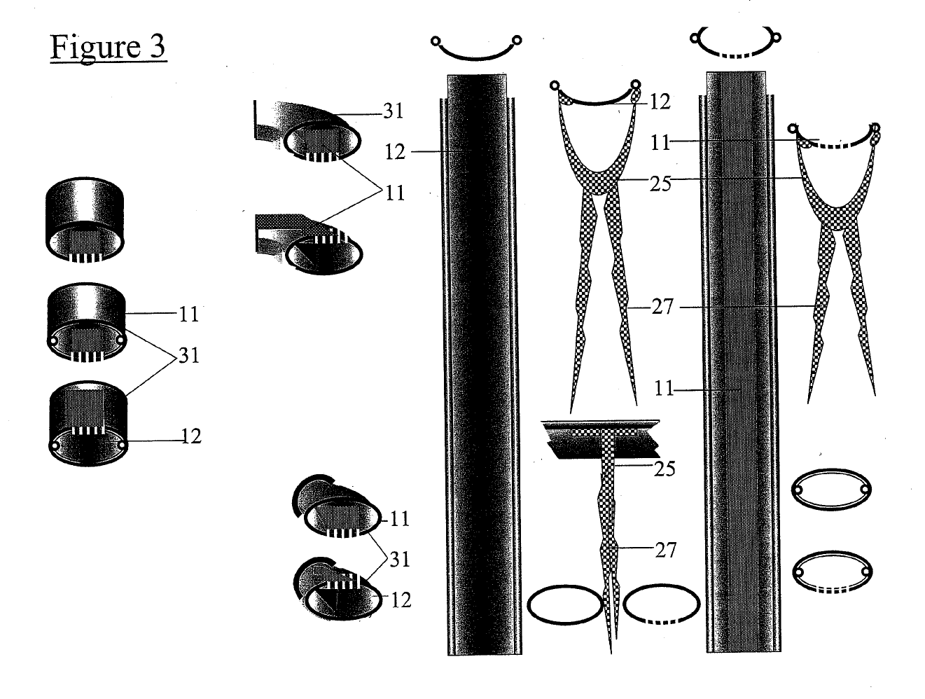

FIGS. 3 & 4 define a trough system to be assembled at a fire event to best fit around a burning structure or along a wild land fire. The trough system comprises, the brackets 25 which hold the trough units. In addition, the system preferably comprises telescoping legs 27 adjusted to heights such that the sequence of them holds the trough (1) above the fire draft height, and, (2) in an descending sequence with the high point where the liquid nitrogen is fed to the system and the low point at the ends of the trough.

Second, the trough unit's leg lengths may be configured for both use with solid troughs 12 and sieve troughs 11, wherein the sieve troughs 11 are configured to rain the liquid nitrogen down on a location to quell a fire or other such crises. In addition, the system comprises a plurality of elbow units 31. The elbow units 31 are configured to conform the trough system to the event. As shown here, elbow units 31 comprise 180°, 135°, and 90° elbows 31. Note that elbows drawn here have dual trough surfaces, i.e., the elbow units may be either solid or comprise a plurality of apertures. As such, fewer elbows will be required at the crisis scene.

The trough assembly may totally surround a fire above the fire draft height so when filled with liquid nitrogen from a cryo-delivery truck, the fire draws nitrogen to every part and extinguishes the fire. Another design may border the fire above the fire draw on one side and quell the fire at that location before being moved to another side thereof.

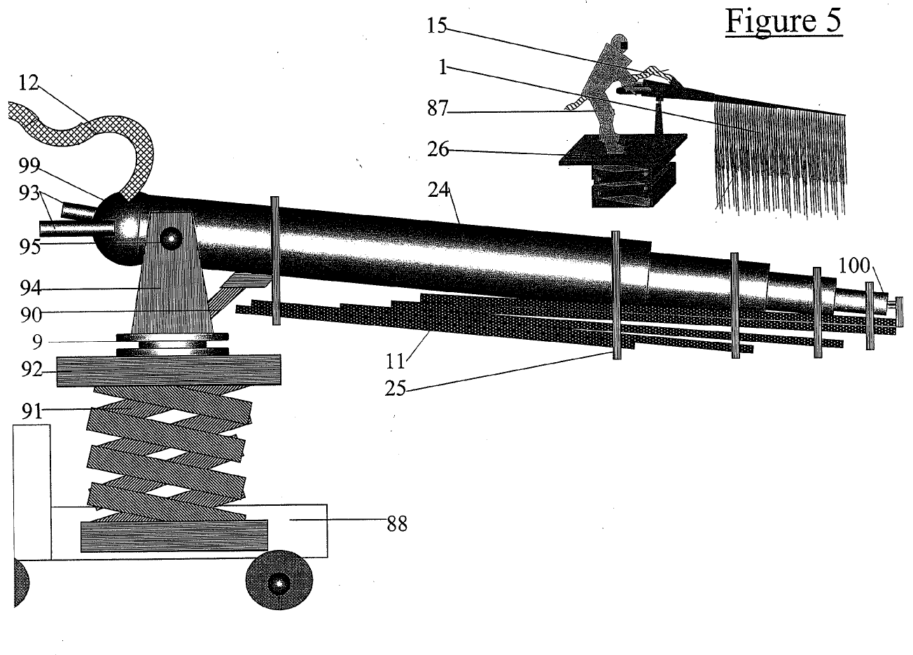

FIGS. 5 & 6 disclose another embodiment of the present invention wherein the present invention includes a wand that can be extended to, preferably, fifty feet, or about sixteen meters. The wand has a wand tube sequence 24 that extends about forty feet, or about thirteen meters and a cross-sectioned rod 100 that carries the sieve trough units 11 another ten feet, or three meters. Brackets 25 connect the right sieve trough to its wand tube unit or cross rod 100 for the furthest one out. Preferably, the wand must extend from the highest point at the lift 91 and allows the liquid nitrogen to flow down hill to the end 100. The lift is preferably mounted on a truck 88 and the like and is topped by a platform 92 where a pivot 9 is mounted holding a stand 94 with a fulcrum 95 attaching to the largest of the wand tubes 24. This wand tube 24 is mounted in a counterbalance and has grips forming handlebars 93 and a cryo-tube 12 or feeder tube 15, which pours the liquid nitrogen into the wand. The angle of the wand is secured by the angle set 90, which is secured to the top of the pivot and the lower part of a first wand segment. As illustrated, the operator 87 directs the wand and controls the liquid nitrogen 1 flow. This flow control may be similar to the accelerator grip on a motorcycle or similar such mechanism. The operator is protected by a full body suit and headgear with oxygen supplied because of the nearness to the fire and possible nitrogen cloud wafting as the fire and winds vary.

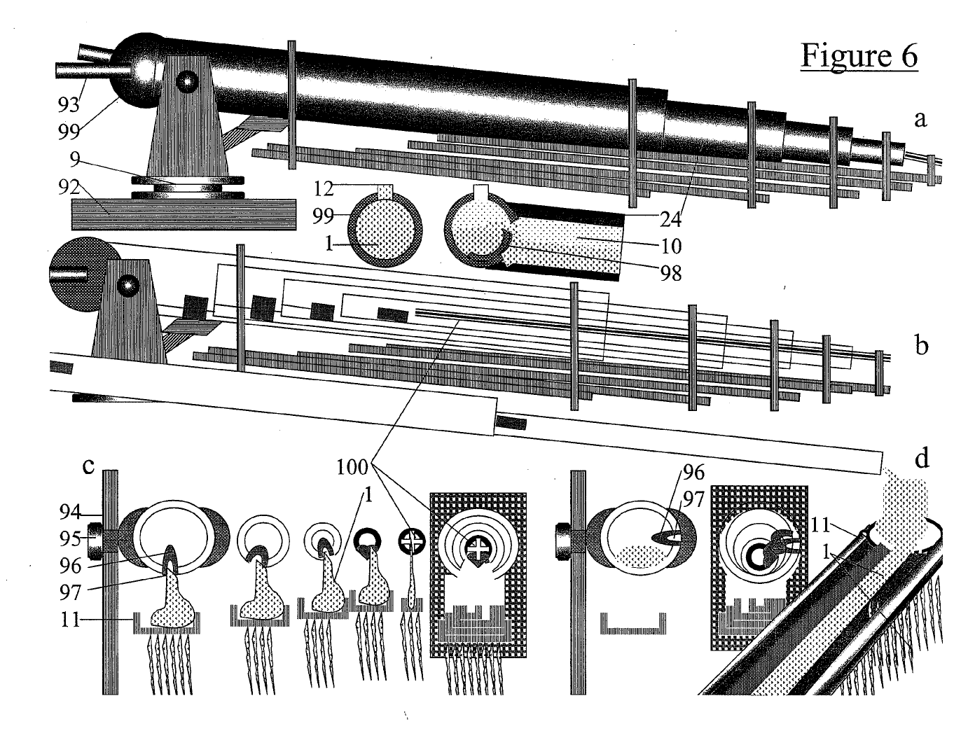

Details of the wand design are further defined in FIG. 6 showing, first the wand tube 24 to counterbalance 99 connection with the cyro-tube 12 feedline and a valve 98 that slides up or down at the junction to control the level of liquid nitrogen in the counterbalance 99. The liquid nitrogen component 1 and nitrogen gas component 10 show the fill circumstance with application of liquid nitrogen through the wand. The heavier the flow of Liquid Nitrogen through the tubes making that side of the fulcrum 95 heavier, the more liquid nitrogen is reserved in the counterbalance 99 by the valve 98.

An auto-trim tab or the like as used in aircraft can be used here to adjust the angle of the valve. Section b shows a cut-away view of the tubes of the wand and the placement of the cross rod 100. Shown there and in section c is the nitrogen catch 96 which diverts part of the nitrogen flow to pass through the opening 97 exiting some of the liquid nitrogen at that point into the sieve trough 11 for that pipe segment. Note each pipe segment has a different part of the liquid nitrogen stream 1 diverted, with the last, feeding the sieve trough under the cross segment feeding out of the end of the last tube segment into the smallest sieve trough unit. Shown also is part of the wand tube mount, the housing 94 and the fulcrum 95.

Section d shows a wand configuration allowing the wand to feed either the wall unit of FIG. 2 or the trough system configuration as shown in FIGS. 3&4. The wand tube set 24 is turned 90° such that the catch 96 and opening 97 are not in the liquid nitrogen stream thus allowing the full volume of liquid nitrogen to flow out of the smallest tube segment. The liquid nitrogen 1 is shown entering a trough 11. With this function, the wand sieve troughs 11 can be set aside if desired.

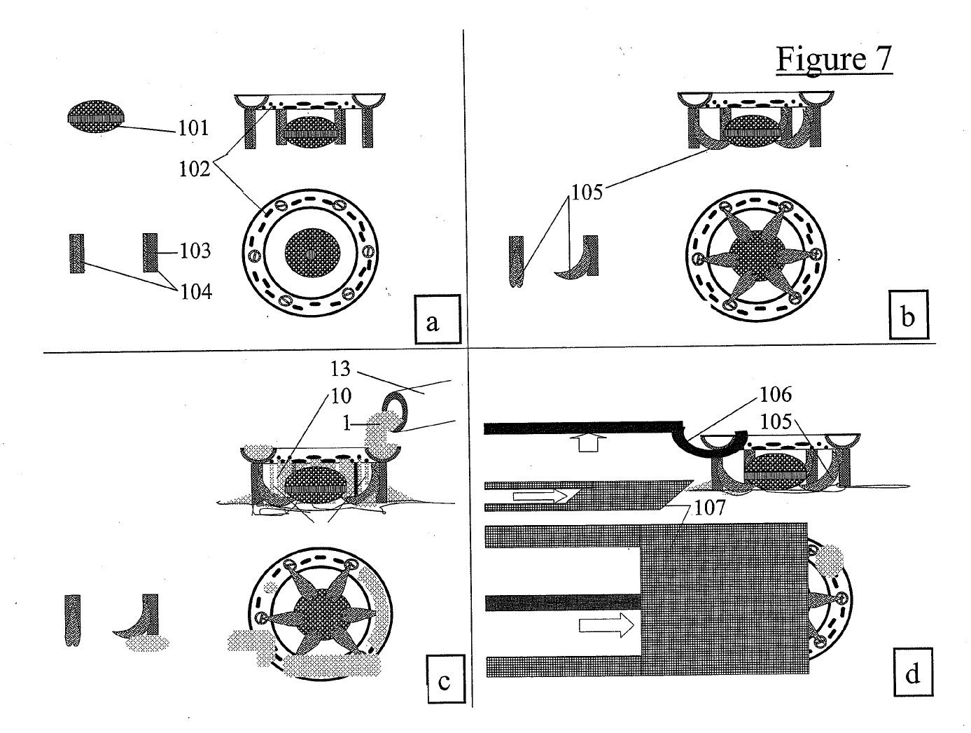

FIGS. 7a-d illustrate another embodiment of the present invention wherein the apparatus is configured to postpone detonation of a discovered unexploded ordnance 101. Minesweeping teams, fire departments, and the like may utilize the present embodiment of the present invention. A dewar 13 or similarly portable container can be used to deliver liquid nitrogen to this particular apparatus. A ring pan 102 is supported by a plurality of extendable legs 103 having hydraulic inserts 104. The ring pan 102 is set in place encircling the ordnance at an elevation higher than that of the ordnance itself to ensure a constant air temperature as shown in section a. As shown in section b, oil or water are used to expand the inserts 105 until inserts 105 work their way under the ordnance and possibly lift it off the ground slightly.

Section c shows liquid nitrogen 1 added from a dewar 13 and nitrogen gas 10 surrounding the ordnance. One might baffle the whole apparatus (see FIG. 20a) to keep the nitrogen gas in the system longer thus cooling the ordnance faster. Note that the water or oil in the inserts is now frozen resulting in a basket effect for holding the ordnance 101.

Section d shows a hook tool 106 used to lift the whole apparatus and ordnance from the ground to enable a shovel or spatula type tool 107 to slide under it and then lift and place it in an appropriate detonation chamber or the like. The leg inserts prevent freezing the ordnance to the ground, which could cause the ordnance to detonate. This particular apparatus is preferably disposable so that the ordnance does not have to be removed from the holder prior to detonation and due to the decreased reliability of the leg inserts after being frozen.

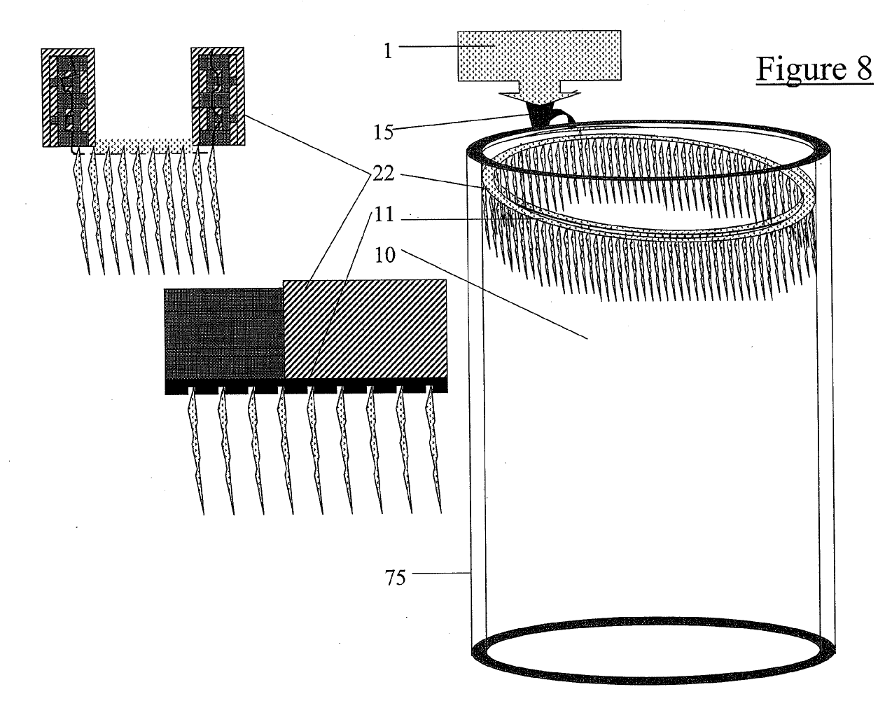

FIG. 8 shows fixed fire control hardware for buildings and other structures such as, for example a silo. Silo fires are potentially dangerous events where methane and other gases from rotting vegetation and infestation build up can cause spontaneous ignition. Proper plumbing for nitrogen purging on a periodic basis can reduce both the infestation and accumulation of methane and other gases. Some fires burn and leave the contents of the silo smoldering. Application of liquid nitrogen will reduce the oxygen level in the silo, which kills infestation and therefore reduces the probability of fire and returns the contents to temperatures below ignition temperature, thus decreasing the risk of a fire.

Applying the fixed liquid nitrogen fire control system to commercial and industrial buildings would allow one to apply the liquid nitrogen to the region of the structure that is burning, to purge all or part of the structure in case of gas leak or even hostage crisis. Different from water sprinkler systems where water rains down on everything at any hotspot, liquid nitrogen will flood the area of the hot spot but not alter the contents or décor. Merchandise, electronics and paper supplies, records and equipment therefore will not be damaged. Were a facility to experience a gas leak, one could fill the structure with nitrogen making it safer to enter. FIG. 8 shows the liquid nitrogen 1 entry into the system via a funnel 15, a wall-conforming sieve trough 11 held in place with a molding 22 that allows sliding to expand to the wall configuration. In use, the liquid nitrogen rains down flooding the structure 75 interior with nitrogen gas 10.

FIG. 9 shows cryo-tubing 12, wherein the cryo-tubing 12 is used to deliver liquid nitrogen to large, fixed liquid nitrogen fire control systems which can consist of either or both distribution hardware as shown in FIG. 2 with the wall mounted unit and/or FIG. 8 with the built in trough system. To insure against icing in the cryo-tubing, liquid nitrogen traps 16 are placed at elbows 31. The length of the tubing 12 determines the depth of the trap 16 in that the length of the trap must be 1/250^{th} of the tubing length to ensure nitrogen flooding of that segment of the tubing. After use of the system, the traps are full because the liquid nitrogen enters them during the flow. When the flow is completed, there is enough liquid nitrogen to evaporate and fill the tubes with nitrogen gas thus insuring humid air does not enter the tubes. A mono-directional valve at any open end will release line nitrogen gas and prevent air from entering the system. Thus the cryo-tubing is bathed in nitrogen gas at all times when not in use.

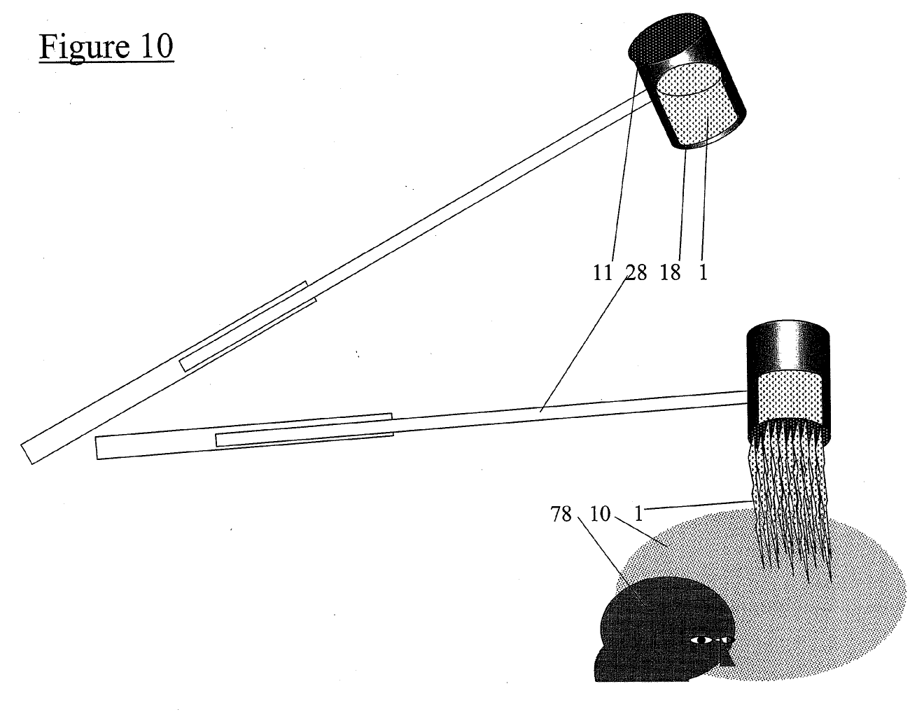

FIG. 10 is another embodiment of the present invention wherein the apparatus may be used as a non-lethal weapon or can be used to extinguish a small fire. Shown here is the telescoping handle 28 holding a container 18 of liquid nitrogen 1 with a cover serving as a sieve unit 11. This device can be filled from the dewar of the equipment shown in FIG. 1. The non-lethal weapon used is shown here with the jar on the telescoped rod turned over so the liquid nitrogen flows out making a nitrogen gas cloud 10 in the breathing space of a suspected hijacker or other criminal 78. With about two breaths of pure nitrogen, the hijacker will enter Nitrogen Coma, when a lung reflex causes loss of the person's diaphragm function stops breathing and causes loss of conscious simultaneously so that the suspect may be restrained. Once restrained, the person can be resuscitated by administering a few strokes of artificial respiration to bring oxygen into the lungs.

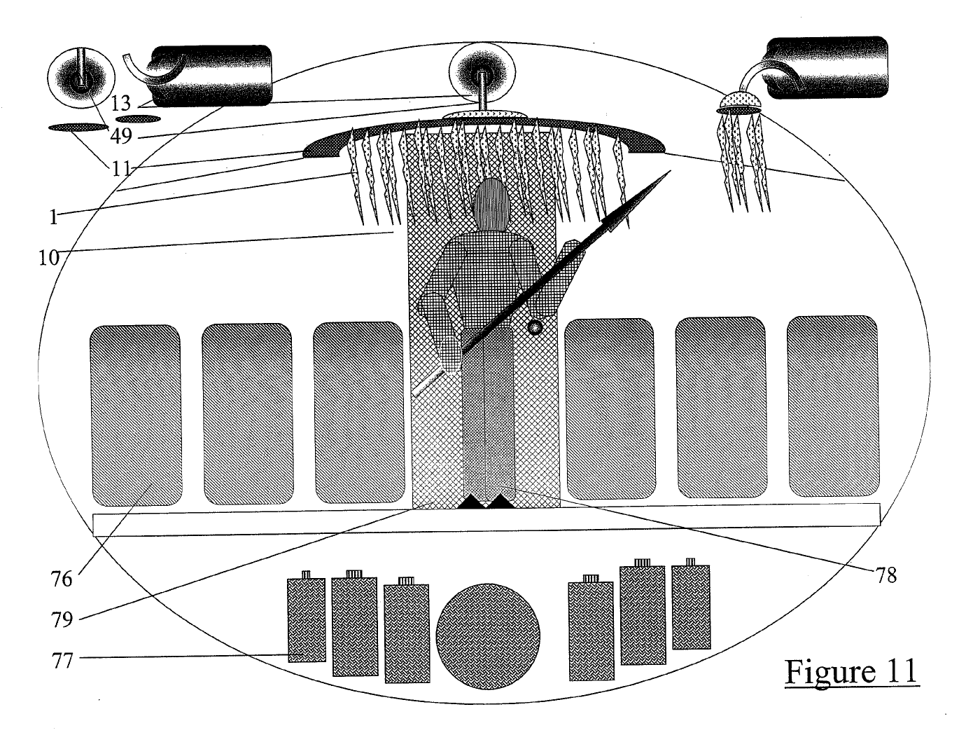

FIG. 11 illustrates a fixed hijacker capture device that can be installed in airliners. When a person storms the cockpit, before the door is opened, the crew can activate a liquid nitrogen drop flooding the space by the cockpit door with nitrogen gas, again, making the person unconscious. This gives the crew and air marshal time to restrain those causing the threat, and then resuscitating them so they can be turned over to authorities. FIG. 11 illustrates a cross-section of an airliner cabin with baggage 77 beneath the floor and passenger seats 76 above. With the hijacker 78 in front of the cockpit door 79, the crew can push the emergency button, which will turn the siphon unit 49 in the mouth of the dewar 13 so as to release the nitrogen gas. In addition, it may also include a heating unit on the siphon pipe inside the dewar to raise the pressure to start the siphon, if needed. Additionally, it is housed in the ceiling area of the airliner cabin. The siphon allows the liquid nitrogen 1 to flow onto a sieve 11 mounted in the ceiling over the cockpit door area flooding the entryway with nitrogen gas 10. Having both the jar on a rod and the cockpit door protected this way should reduce terrorist acts and hijackings on airliners. This can be used in other sensitive areas as at the opening of a bank vault or security point.

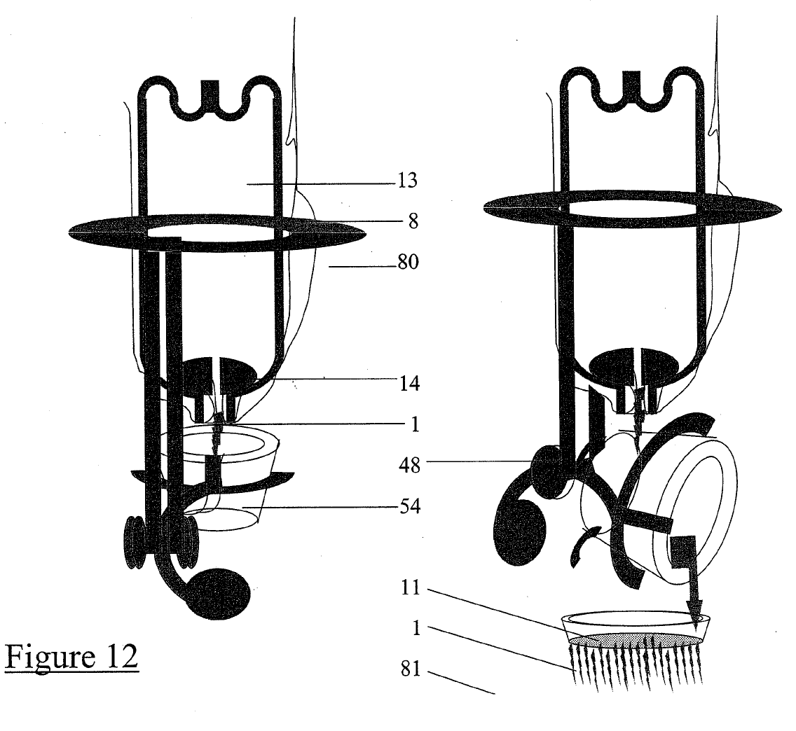

FIG. 12 shows another embodiment of the present invention wherein the apparatus is utilized to control a fire in the form of a long-term burn of coalmines, compost heaps, peat bogs, and the like. The dewar 13, like in FIG. 1, holds the liquid nitrogen 1 and is placed in a drilled hole 81. A baffle 14 in the dewar 13 allows a slow flow which fills a cup 54 which, when the weight of the contents is sufficient, tips and drops the liquid nitrogen onto a sieve which sends the cold droplets down the hole 81 to the bottom. Because the evaporant, nitrogen gas, is cold, it displaces air at the bottom of the hole and will seep through the porous layers thus displacing any oxygen and cooling the temperature at the depth of the drilling. To control one of these long-term burning fires, holes may be drilled in a square matrix over the burn, drilling down to boiling water or other selected temperature of the substrate. The device 80 is then inverted into the top of the hole with a baffle ring 8 holding against the top of the drilling to keep nitrogen gas in the hole. The device is refilled with Liquid Nitrogen on a scheduled basis and applied. Once the temperature at the bottom of the hole rises sufficiently, the hole is drilled deeper until it reaches the selected temperature. The process is then repeated. When there is no more heat produced down any hole, it can be assumed that the fire is out in that location. Repeating this throughout the matrix will end the burn. Where heat at the bottom of an array of drillings in the matrix persists, new drilling in the center of the squares can be added to further hasten burn control. Distance between holes in the matrix is estimated at 25 feet, or about 8 meters.

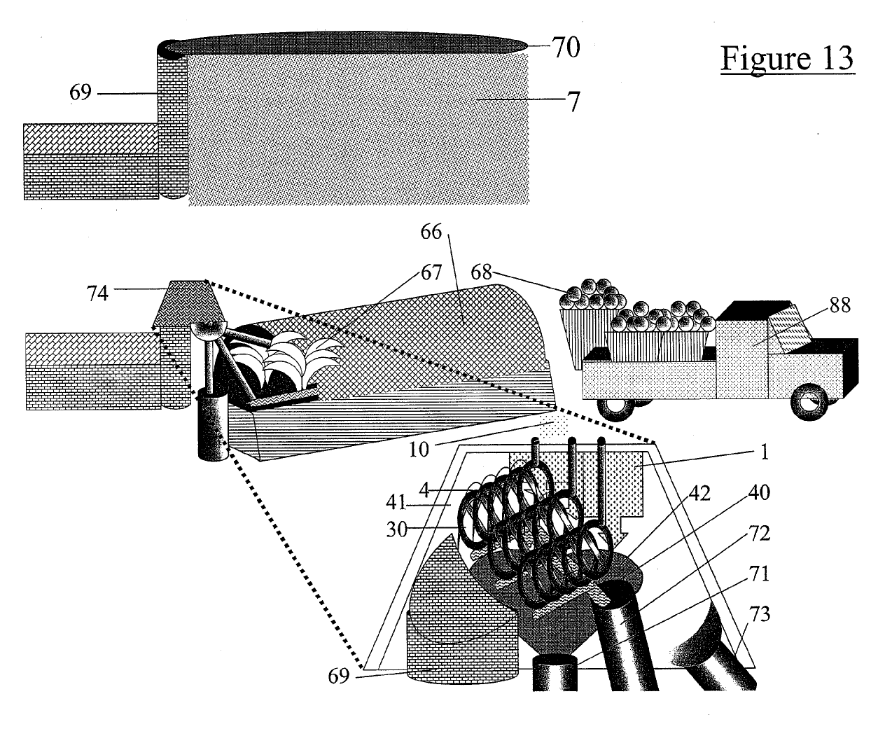

FIGS. 13 & 14 illustrate means to capture stack gas 41 from industrial chimneys, specifically, but not limited to coal burning energy facilities, where what is normally released in the atmosphere is captured and processed with some by-products. In FIG. 13, the general concept is to convert the smoke 70 and particulates and pollution of the air 7 emerging from chimney 69 by capping the chimney with a housing 74 containing the chimney top 42 releasing smoke 41 to multiple sets of liquid nitrogen cooled condenser coils 30, which, when filled with liquid nitrogen 1 generate an ice 4 crust, and release gaseous nitrogen 10 into the air. The coils 30 are cooled alternating between units so as to let the ice 4 melt into water 40 and flow down the water pipe 72. This lowers the humidity causing the soot 42 to be released and fall out of the air, which is collected on the floor of the chimney cap structure and funneled into the soot pipe 71. Residual, dry air rich in Carbon dioxide is removed via air pipe 73. This is a continuous, ongoing, scrubbing of the factory emissions.

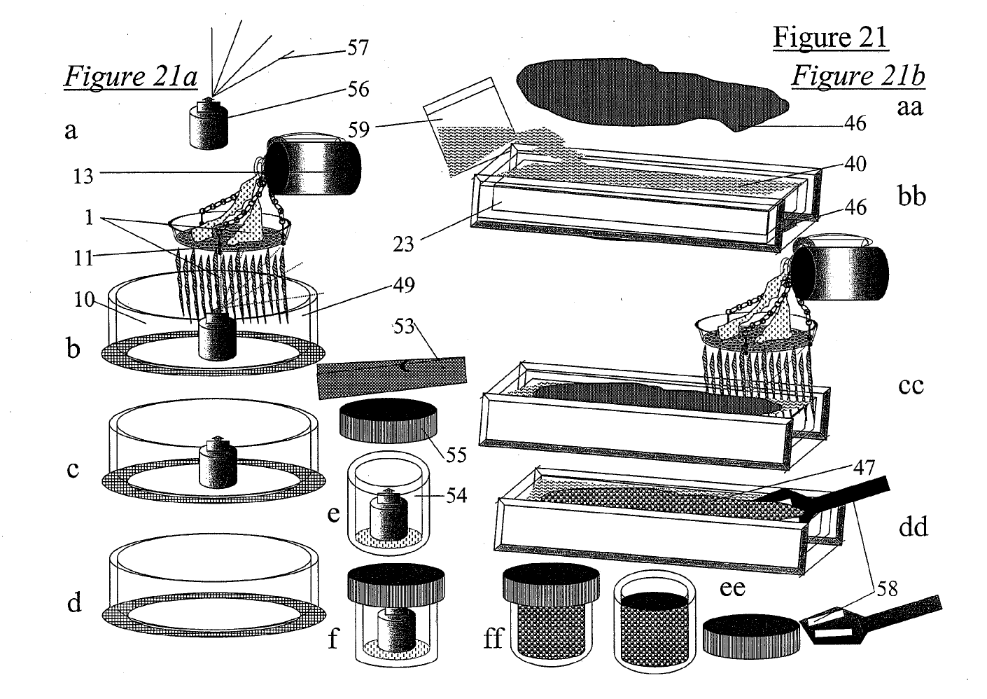

To beneficially use the stack gas output, a greenhouse 66 is constructed in conjunction with the chimney cap 74, in which plants 67 are nourished with the Carbon dioxide from pipe 73 through photosynthesis. There may be need of additional oxidation of air components that will be oxidized with an open flame at release of the gases from in the greenhouse 66 or recycled through the boilers in the facility. The water pipe 72 provides water for the plants. With remaining liquid hydrocarbons, in the water, the water can be put in a cistern and the surface cooled as shown in FIG. 21b and the hydrocarbons skimmed off and recycled in the coal burning process. The water is then used for the greenhouse plants 67. Eventually produce 68 is harvested and trucked 88 off to market.

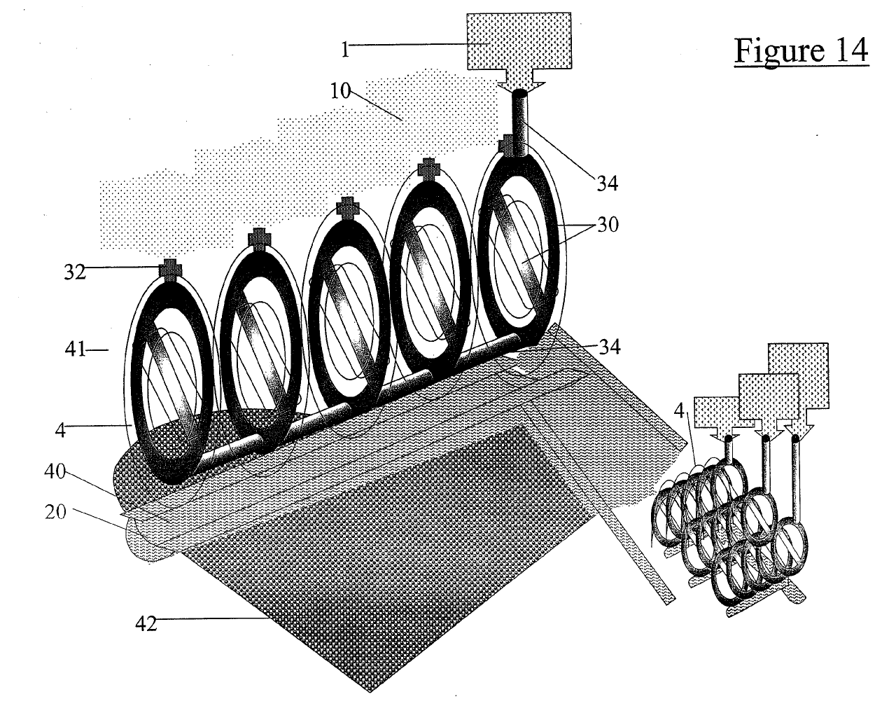

In FIG. 14 the coil structure 30 is shown in more detail. Liquid nitrogen 1 is fed into the coils 30 through the entry pipe 34 feeding the first coil in the sequence. The feeder pipe 34 between the coils feeds the sequence of coils 30 such that the liquid nitrogen levels of all the coils in that sequence will be the same. The coils emit hot nitrogen gas 10 out of the exhausts 32 as the hot smoke cools and humidity in the air condenses on them as ice 4 and releases the particulate matter 42 clinging to the water vapor. While one coil sequence is cooled, other sequences are not allowing the ice 4 to melt into water 40, which drips into the trough 20 feeding eventually into the water pipe.

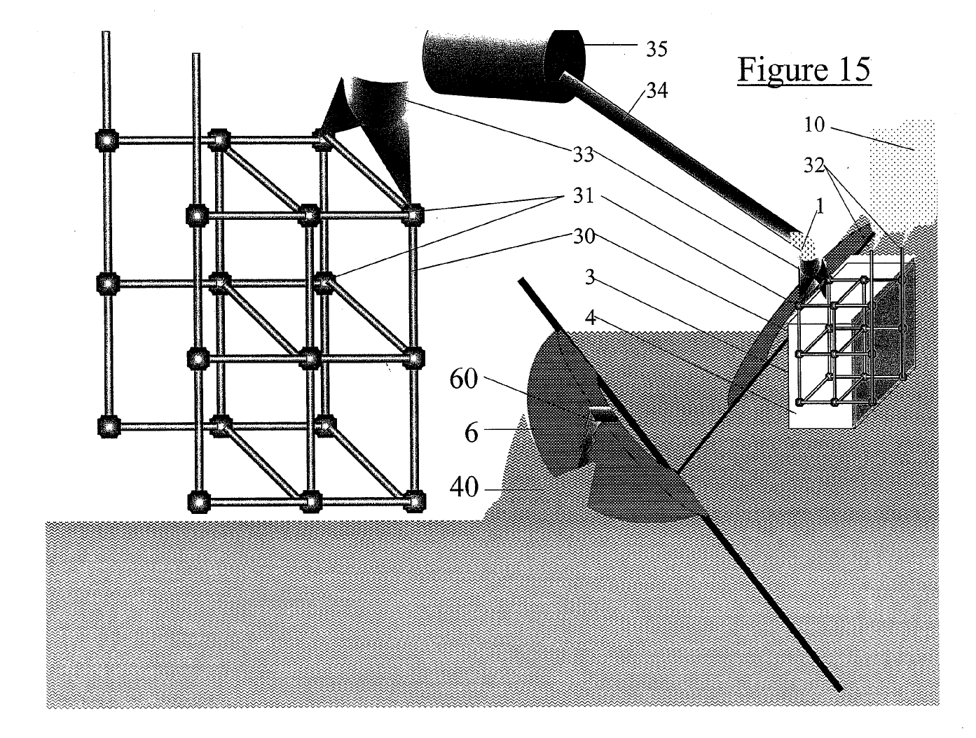

FIGS. 15 & 16 show means to place a temporary repair on a dam or dike 6 with a hole or breach 60 in its structure holding the water 40 back to prevent flooding downstream. FIG. 15 shows the basic components on a square pattern of pipes 30 held together in a structure with elbows 31. It has a funnel 33 feed for liquid nitrogen 1 which is supplied by a cryo-tank 35 feeding many gallons of liquid nitrogen into the structure via the feeder tubing 34. Nitrogen gas is released from the pipe structure through open exhaust pipes 32. This cooled structure causes the ice 4 to form on the structure freezing the water 40 in the river, stream or reservoir. As ice forms a solid block on the structural pipes, it blocks the flow to the breach in the dam or dike. This returns control of water flow and also allows empty dry, but cold, space for workers to repair the breach while the ice patch is in place. Once the repair is strong enough to hold back the water, liquid nitrogen 1 is no longer fed into the pipe structure. The ice melts and the pipe structure is pulled from the water and taken away.

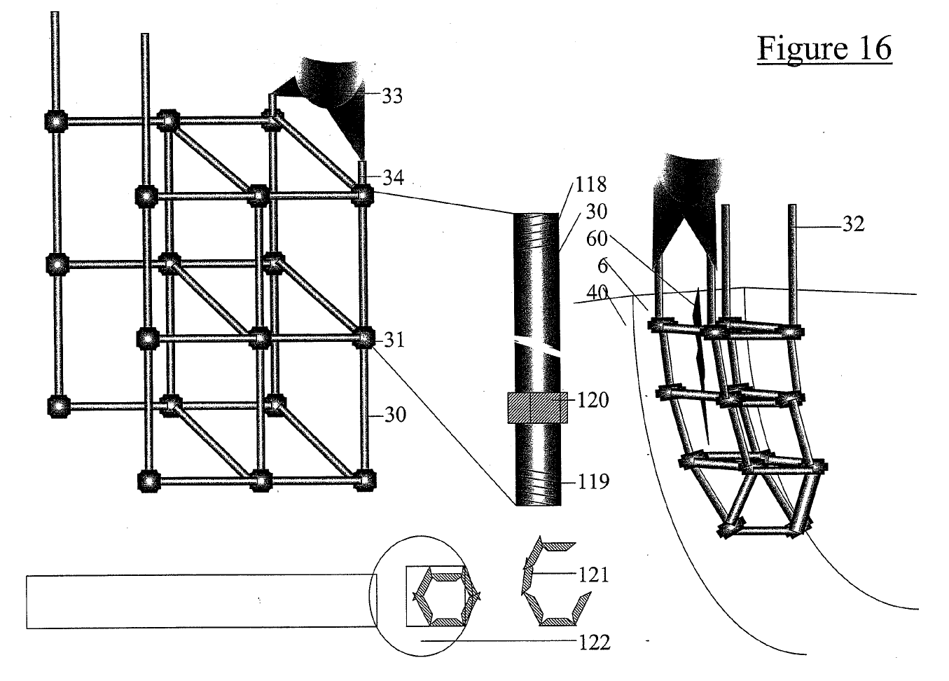

FIG. 16 shows a means to conform the pipe structure to the curvature of the dam or dike up-water surface using pipes 30 that are threaded in opposite directions 118 & 119 on the ends of the pipe and a hex-structure 120 turning capability, either fixed 120 or removable 121 so the pipe length can be altered by turning the pipe with a wrench 122. The dam 6 curvature is illustrated showing the conforming pipe structure with the breach 60 clear of the ice structure foreseen with the design of the pipe configuration. During application either configuration can be iced in a place of placid water flow and pulled into the water stream at the breach location.

Another embodiment utilizes on-site moldable elbows 31, which possess undefined angles needed by dimensional changes in the piping. This can be handled in at least two ways. First, the elbows could be molded in place using a low temperature mixture of Woods Metal and Indium to reduce the molding temperature to around 60° C. The flow channels would be formed using Popsicle-like ice bars and t-shaped, x-shaped or hex-shaped outlets per elbow. The outside elbows may have five pipe outlets and the corner elbows may have three x-shaped outlets. Second, a plastic material capable of tightly holding the threaded areas may be used. Many such materials are used in medical efforts for patient comfort such as foams and gels. These materials would have to retain strength at low temperatures as liquid nitrogen passes through them.

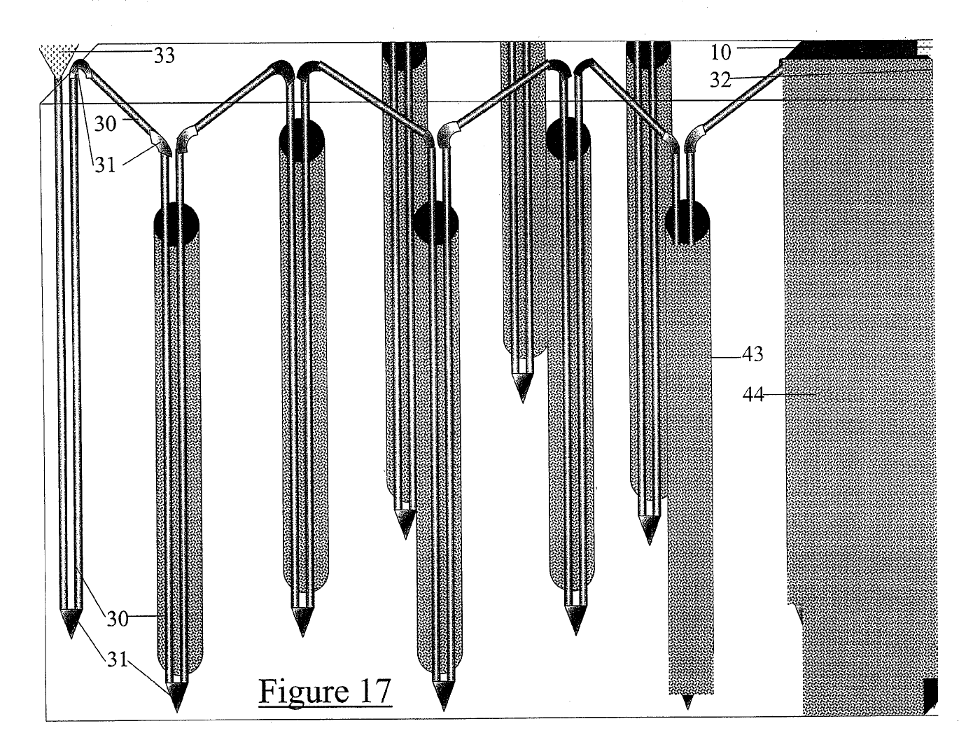

Another pipe structure, illustrated in FIGS. 17-19, creates an ice-gravel solid core 4 for the height, length, and breadth of the pipe system plus about six inches for a levee needing augmented strengthening in the case of the occurrence of a hurricane stronger than the levee is certified to hold or in a mudslide zone. FIG. 17 shows the pipe system segment with the funnel 33 to feed liquid nitrogen on a freezing pipe 30 with elbows 31 at the bottom holding a second pipe and at the top connecting that pipe with the entry pipe of the next pair. These are placed down holes 43, which are drilled in the levee 44 and then these holes 43 are filled with gravel of similar consistency as that of the levee. The pattern of piping is a zigzag so as to get a broader freeze zone 3. To further broaden the freeze zone, parallel pipe systems may be used so the ice-gravel structure is broad enough not to topple. It is estimated that the freeze zone will be four feet wide, or more than three meters in the illustrated double pipe structure.

Once installed, this pipe structure from the funnel entry through the exhaust is sealed to prevent water or other material contamination. When a hurricane is approaching, the caps on the funnel and exhaust ends of the pipe system are removed and liquid nitrogen 1 is poured in by the cryo-truck load, about 7,500 gallons.

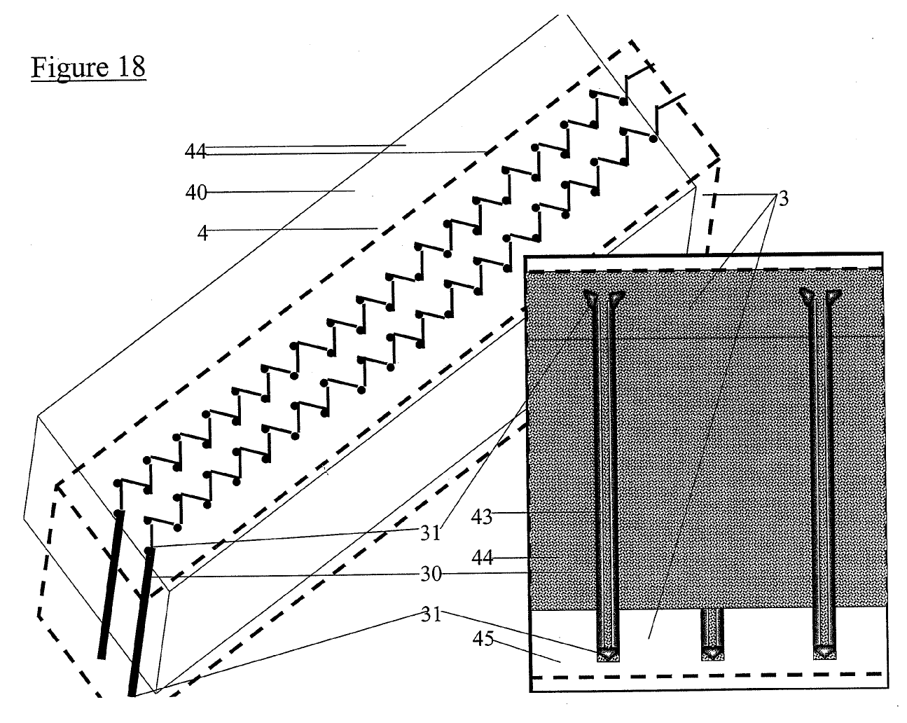

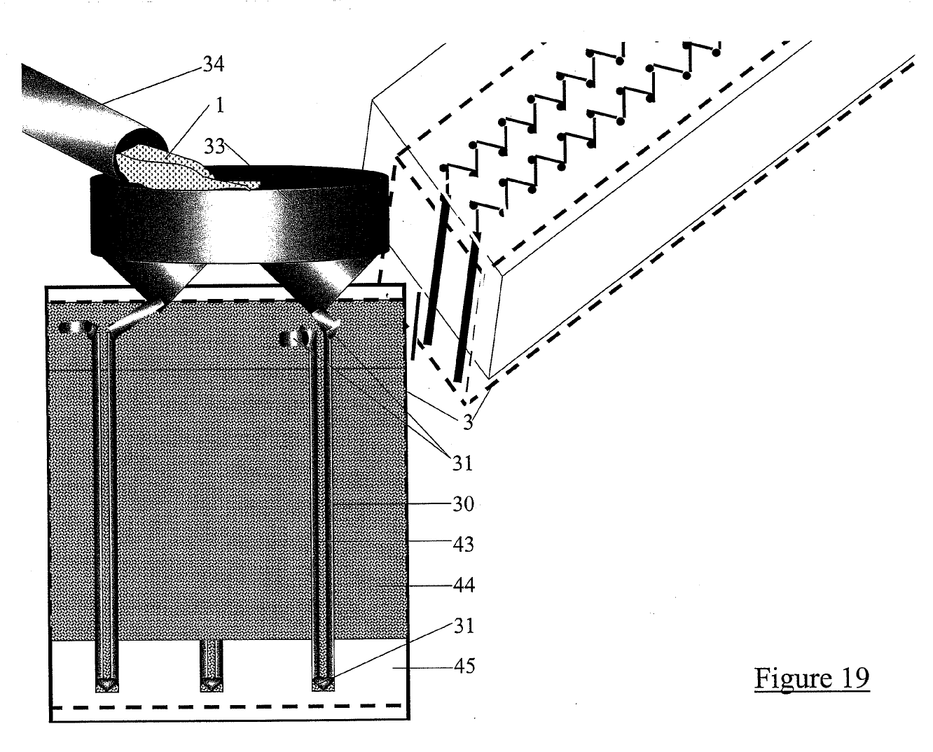

FIG. 18 shows the pipe pattern and ice core 4 both dimensionally and in a cross-section wherein the freeze zone includes the levee 44, holes 43, river bottom 45, and fill at the top of the pipes. It is preferred that the pipe system extends the fill width of the levee for effectiveness against the raging floodwaters from the anticipated storm. FIG. 19 shows the filling process wherein the feeder pipe 34 from the cryo-truck pours liquid nitrogen 1 into the funnel 33 which feeds both pipe systems installed in parallel. The freeze zone 3 is defined with the margin shown as a dotted line.

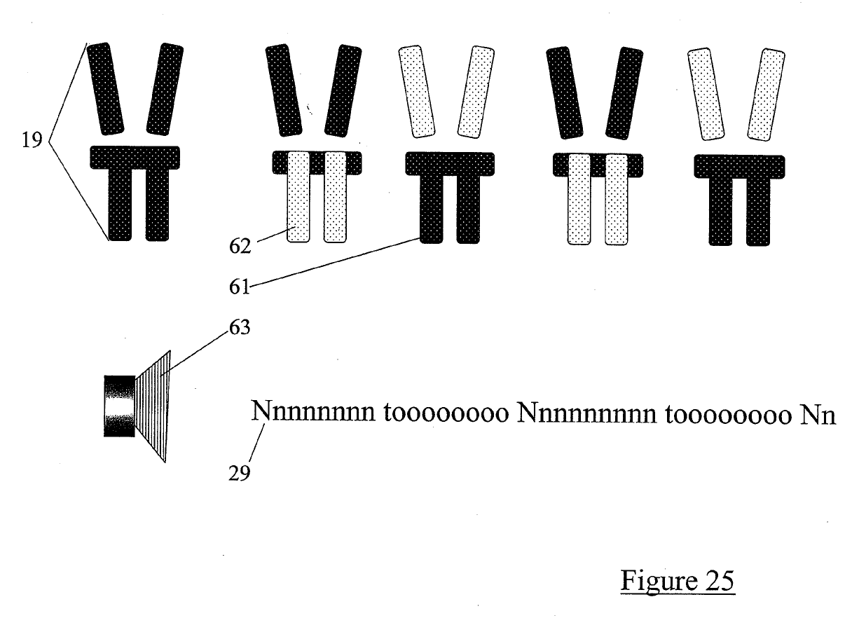

Upon filling these pipe systems, the exhaust end of the pipe systems will be spewing huge amounts of gaseous nitrogen. If the air is still this will form nitrogen clouds and could cause danger to those nearby. Thus, for safety, a fan system is preferably supplied at the exhaust pipe. Also, the “n” “2” alarm shown in FIG. 25 can be provided at that location to provide both visual and auditory signal

The freezing apparatus of FIG. 20 illustrates another embodiment of the present invention wherein the apparatus is configured to catch and solidify a lava flow 64. This structure leaves a permanent landform after application. It is an opportunity to structure the future rock 65 to useful configurations as shown in FIG. 20b, where the freezing piping 30 can be converted to water and power wiring delivery and even include a dam structure to hold a water reservoir or lake providing water and recreation in the future. Anticipating the lava reaching a specific location, the structure is built with the freeze piping 30, elbows 31, feeder pipes 33 receiving liquid nitrogen 1 and exhaust pipes 32 releasing nitrogen gas 10. As the lava flow 64 encounters the pipe system, liquid nitrogen is delivered to the pipe system by truck or helicopter filling the pipe system with liquid nitrogen 1. This coldness immediately solidifies any lava contacting the piping making it solid rock 65 with pipe penetrations at locations of the cold nitrogen. Continuous supplying of liquid nitrogen to the system cools this rock so advancing lava also solidifies making the lava rock depth significant. When the lava flow subsides, then the rock structure developed is part of the earth's surface and can be used as desired. This has at least two purposes: first, to protect things below this structure from lava invasion at the time of the flow; and, second, to prepare for use after the lava flow.

FIG. 21a illustrates another embodiment of the present invention wherein an apparatus is provided to protect against the release of a toxin 57 from an aerosol can 56 or the like. To insure the whole aerosol is going to be steeped in cold nitrogen gas 10, (b) a baffle 49 having a height greater than that of aerosol or canister is erected around the aerosol, and the emergency hand carry dispenser of FIG. 1 is used to rain liquid nitrogen 1 through the sieve 11 placing the coldest possible nitrogen gas 10 in the baffle. This cools the aerosol and the contents condense in the can stopping the dispersion of material, whatever it is. For safety, a tongs 53 or the like is provided for lifting the aerosol out of the baffle and placing it in a jar 54 with a sealable top 55.

FIG. 21b shows an apparatus configured to raise a spill (aa) by cooling the spill so that it solidifies for easy removal. First, the user surrounds the spill material 46 with a baffle 23 (bb). Next, the user adds water 40 from a container 59, such that the spill rises to the surface of the water. Then using the emergency device from FIG. 1, (cc) the spill is cooled on the water surface. As it solidifies or gels (dd), a skimmer 58 is used to take the spill material from the water surface and place it in ajar 54 (ee) with a sealable top 55. Once it is sealed in the jar (ff), it can be allowed to warm up and again become liquid. Seal the top on the jar and take it to authorities or do as directed to dispose of the material.

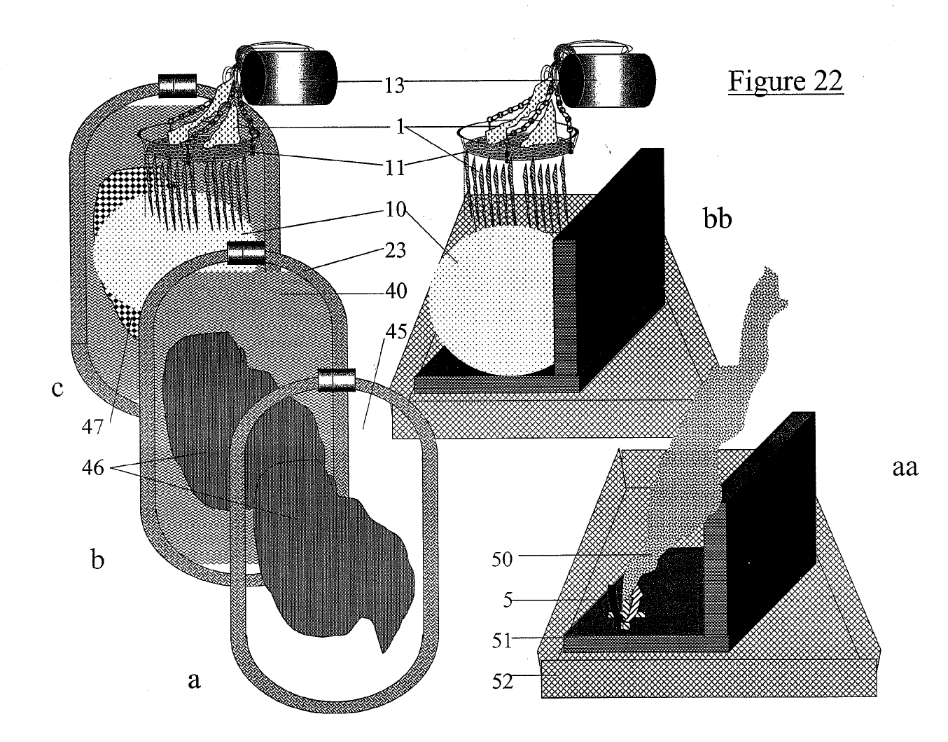

FIG. 22a shows a similar circumstance to that in FIG. 21b, only the spill 46 on the surface 45 that won't easily release this larger spill substance, when cooled and in larger volumes. Here, the user fills a fire hose with water and seals the ends together (a), using it as the baffle 23. Next, the user floods the hose enclosure with water 40 (b), uses the FIG. 1 emergency device with its dewar 13 and sieve 11 to place liquid nitrogen 1 in the sieve and rain its droplets so as to evaporate them into severely cold nitrogen gas 10 to reduce the temperature of the substance 46, solidifying it 47 on the surface of the water (c). It is then skimmed up and placed in a sealable container for moving it to the proper facility as directed by authorities.

FIG. 22b illustrates an apparatus for quelling a computer battery fire 5 in a place where space is at a premium such as on an airliner. A pan 52 with a bottom in tact is placed on the floor. The burning 5 computer 51 is placed in the pan (aa). Preferably, the sides of the pan are elevated with respect to the computer part on fire. As illustrated, smoke 50 is pouring out of the computer. Then (bb) the emergency device from FIG. 1 is used to rain liquid nitrogen 1 onto the burning device filling the pan with nitrogen gas 10 ending the fire immediately. No arcing of electricity or computer circuitry damage beyond what the fire may have caused is inflicted on the device making repair much more affordable than were the fire put out with water or foam or even Carbon dioxide.

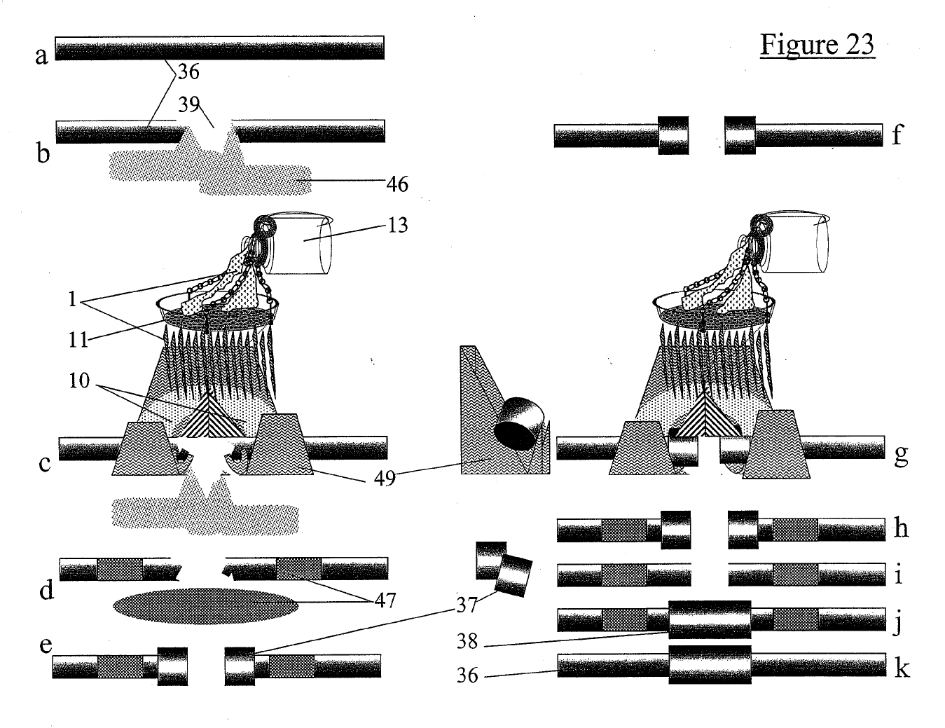

FIG. 23 illustrates an embodiment equipped to handle a break 39 (b) in a hose or pipe 36 (a) and spilling of its contents, such as water, natural gas, or hydraulic fluid 46. Again, using the emergency device in FIG. 1, the dewar 13 and sieve 11, (c) liquid nitrogen 1 is rained in droplets into a two-legged baffle 49 that fits around the two segments of the pipe cooling its contents to freezing. The frozen material stops the flow (d) allowing one to cap 37 the pipes (e). Upper right on the page, (f) the capped pipes return to room temperature having liquid or gas contents. Again freezing the pipe sections with liquid nitrogen droplets (g), the pipe contents are again solid near the break (h). Caps 37 are removed from the pipe (i), and a repair segment 38 is moved onto the pipe (j) and sealed into place. The repaired pipe warms up to room temperature (k) and is back in service.

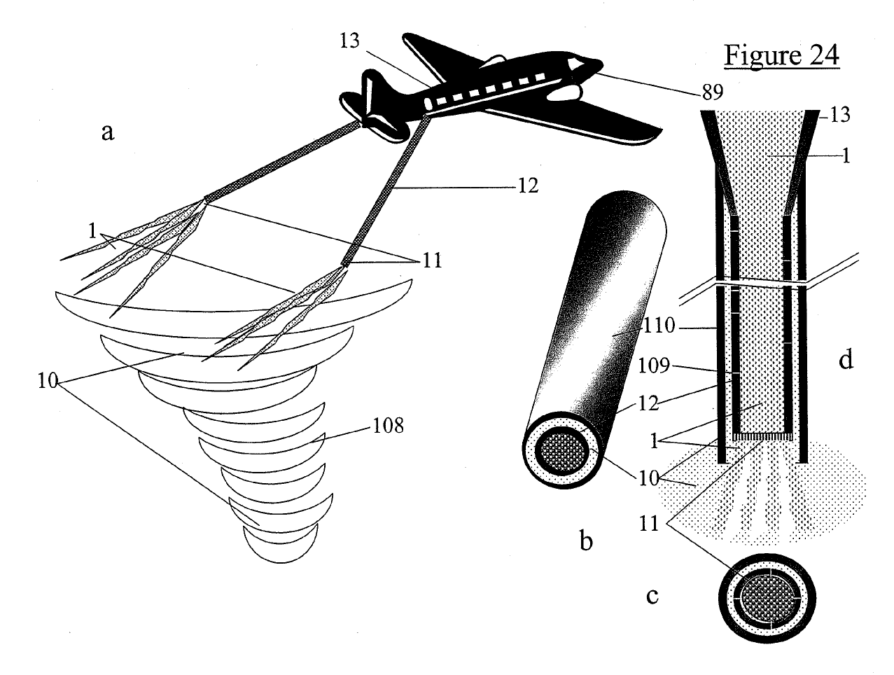

FIG. 24 illustrates an embodiment of the present invention for use in the presence of a tornado cloud. Cloud seeders or the like, can use their planes 89 with a large dewar 13 of liquid nitrogen (a) to disperse liquid nitrogen 1 into the tornado 108 by delivering the liquid nitrogen 1 by way of cryo-tubes 12. The liquid nitrogen 1 evaporates to 250 times the volume of the liquid nitrogen, thus increasing the pressure and decreasing the temperature to help prevent the tornado. To prevent icing of the apparatus, the drawings in b, c, and d show the dewar 13 with liquid nitrogen 1 feeding into the cryo-tube 12 with a sieve unit 11 at its end, dispersing the liquid nitrogen in droplets. An outer tube 110, which is insulated and heated, shields the cryo-tube 12. The cryo-tube here has openings in its walls 109 letting minute amounts of liquid nitrogen out evaporating into nitrogen gas 10 between the tubes. This prevents icing between the tubes and also, because the feed is continuous, pours out of the pipe at the sieve area surrounding it with nitrogen gas keeping the water vapor away from the nozzle area. The outer tube 110 is heated to just above ambient temperature to ward off icing there as well. Without this deicing feature, the apparatus could develop ice at its end, which would greatly interfere with the handling of the aircraft. If the pressure of the tornado is raised with nitrogen gas, it will disturb the action in the cloud. If the temperature is lowered, it may cause snow rather than rain, thus minimizing the effects of the storm.

FIG. 25 shows a signal device configured to detect nitrogen gas concentrations. Preferably the device comprises four light bars 19 that are capable of being either on 62 or off 61. Patterned as shown, in finger spelling for deaf people, the first light pattern on the left reads “n” and the second “2” and repeating, “n” “2”. The chemical abbreviation for the nitrogen molecule is N₂. In addition, an accompanying sound signal 63 can audibly alert the user to the presence of the N2 29.

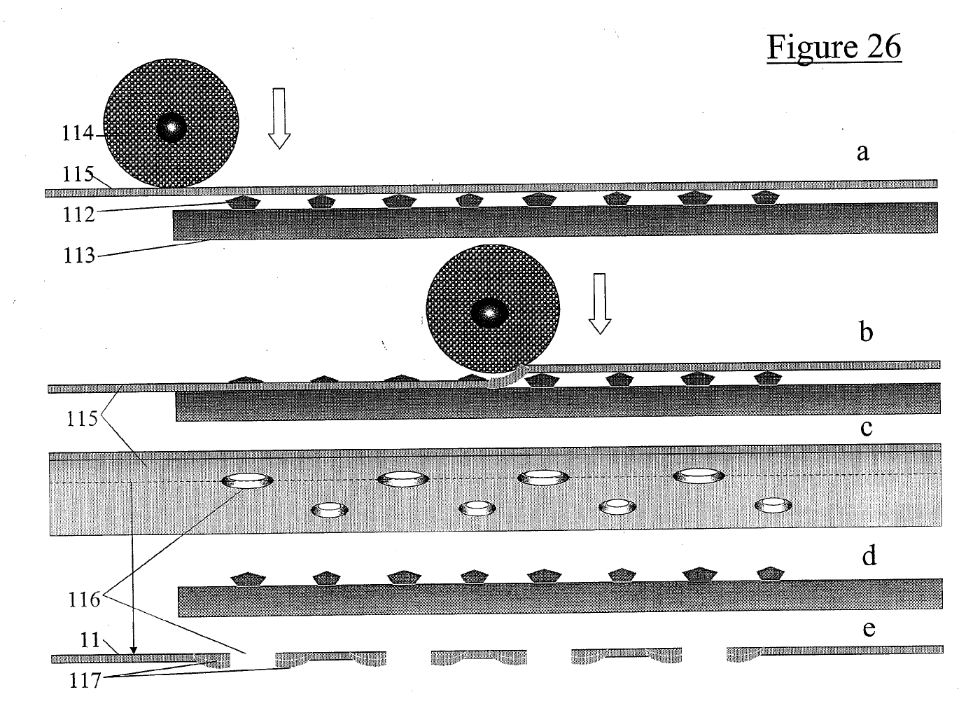

FIG. 26 shows a method of manufacturing the holes or apertures in the sieve 11 so as to alleviate the cracks and damage to the material. Because liquid nitrogen is severely cold and fires severely hot, the drill induced damages can weaken the delivery apparatus and cause it to fail by breaking out large holes ending the drop stream feed. Pressing should mold the holes in the material making less form damage. A press roller 14 of great weight may be rolled over the mold base 113 with hobnails 112 of the hole size on the sheet material 115. The mold is set (a), the roller passes over the sheet (b), and the process is complete (d). The sheet material is shown in (c) showing a perspective view of the holes 116 with openings. A dotted line indicates the cut. The cross-section (e) illustrates the extra material 117 from where the hole was pressed and is gathered on the outside of the device at the aperture locations. These enlargements cannot be on the inside where the liquid nitrogen is poured because it might prevent the liquid nitrogen from passing through the array of apertures evenly, being prevented by large material buildup at the place where liquid enters the aperture area.

Many changes and modifications could be made to the invention without departing from the spirit thereof. The scope of some of these changes can be appreciated by comparing the various embodiments as described above. The scope of the remaining changes will become apparent from the appended claims.

I claim:

1. A liquid nitrogen delivery device comprising:
a dewar for storing liquid nitrogen;
a container for receiving the liquid nitrogen from the dewar, the container having a plurality of apertures for flow of the liquid nitrogen therethrough, wherein the liquid nitrogen is applied to a fire or other crisis; and
a connector, wherein the connector couples the dewar to the container.

2. The device of claim 1, further comprising a holster configured to secure the dewar and a clip configured to secure the container to one of a wall, interior of a vehicle, and exterior of the vehicle.

3. The device of claim 1, further comprising a means for mounting the container to one of a wall, window, and above a door.

4. The device of claim 3, further comprising a pipe for delivering liquid nitrogen to the device.

5. The device of claim 3, wherein the device is configured to purge and flood a structure.

6. The liquid nitrogen delivery system of claim 1, further including a plurality of baffles, wherein the baffles are configured to direct airflow around a target area.

7. The liquid nitrogen delivery system of claim 6, wherein the plurality of baffles is configured to encircle a liquid spill and the system is configured to deliver water to the liquid spill such that the liquid spill is solidified for removal.

8. A liquid nitrogen delivery system comprising:
at least one trough, wherein the at least one trough may be one of apertured or solid;
a plurality of telescoping legs;
a plurality of brackets coupled to upper ends of the telescoping legs, wherein the brackets are configured to support the at least one trough, wherein liquid nitrogen is poured into the system at an end, and the system is configured to deliver the liquid nitrogen to another end thereof; and
a plurality of elbow-shaped units, wherein the elbow-shaped units are configured to conform the trough segments along a desired pathway such that cryogens may be dispersed at a desired location.

9. The liquid nitrogen delivery system of claim 8, wherein the trough system can be housed in a wand, wherein the system is removably coupled to a lift to facilitate portability.

10. The liquid nitrogen delivery system of claim 8, wherein the elbow units are one of apertured and solid.

11. The liquid nitrogen delivery systems claim 8, wherein the system may be configured at a plurality of elevations to facilitate liquid nitrogen dispersal from an area above a fire draft.

12. The liquid nitrogen delivery system of claim 9, wherein the system is configured to use a mass of liquid nitrogen to counterbalance a flow of liquid nitrogen in extended tubing and apertured troughs.

13. The liquid nitrogen delivery system of claim 9, further including trough segments configured to disperse liquid nitrogen over one of a distance substantially equal to that of the system and a distance substantially less than the length of the system.

14. The liquid nitrogen delivery system of claim 8, further including a doughnut shaped pan having apertures and legs including hydraulic inserts and hydraulic fluid disposed therein, wherein the legs are configured to be inserted under and lift an unexploded ordnance.

15. The liquid nitrogen delivery system of claim 14, wherein the system is configured to apply liquid nitrogen to the pan and the unexploded ordnance so as to prevent its detonation.

16. The liquid nitrogen delivery system of claim 15, further including a baffle configured to be substantially taller than the height of the system.

17. The liquid nitrogen delivery system according to claim 8 whereby a wand delivers the liquid nitrogen to the trough, wherein the trough is one of pre-installed and assembled, wherein the system is configured so as to place nitrogen gas in a fire for a range of pathways at a height just above a fire draft and to purge surrounding air by flooding the surrounding air with the nitrogen gas.

18. A system configured to solidify a gas or liquid, strengthen a structure or the ground, and pull pollutants from the air comprising:
a plurality of cooling pipes;
a plurality of elbows, wherein the elbows are configured to couple the cooling pipes to one another;
an entry point for liquid nitrogen in at least one of the cooling pipes;
exhaust outlets for gaseous nitrogen; in at least one of the cooling pipes
a signal means to warn of pure nitrogen clouds coupled to the system, and
an air mixing means at the exhaust outlets.

19. The system according to claim 18, wherein the pipes are threaded in a first direction on one side and threaded in a direction opposite of the first direction on another side thereof.

20. The piping system in claim 18, wherein the system is configured to be installed at a location prior to the occurrence of a crisis, such that the liquid nitrogen may be supplied to the system at a time of the crisis so as to eliminate a possible effect of that crisis.
